(19) United States
(12) Patent Application Publication
(10) Pub. No.: US 2008/0183645 A1
(43) Pub. Date: Jul. 31, 2008

(54) MEDIA CONTINUITY SERVICE BETWEEN DEVICES

(75) Inventors: Michel C. Burger, Woodinville, WA (US); Balakumaran Balabaskaran, Kirkland, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/669,821

(22) Filed: Jan. 31, 2007

(51) Int. Cl. G06F 15/18; G06F 15/16

(52) U.S. Cl. 706/12; 709/205

(57) ABSTRACT

A system that provides the ability to monitor, capture and recreate states of media consumption (e.g., channel, timing) is provided. More specifically, the innovation provides for the ability to identify a context in which a plurality of components collaboratively participate in decisions of transferring a media. In accordance with the context, the innovation can save current states of a ‘session’ (e.g., Internet television, radio, instant messaging conversation) thereafter being able to recover the state of the session on other devices that are connected to the same context as the original device. Accordingly, the session (e.g., media consumption) can be continued via an alternative device. In other aspects, for example where the session represents live media, a recorder can be employed to store (e.g., cache, buffer) the media for later broadcast in accordance with the continuity service.

### BACKGROUND

Both enterprises and individuals are increasingly interested in using handheld and portable devices such as mobile telephones, personal data assistants (PDAs), notebook computers, handheld computers, laptop computers, etc. Most modern handheld devices are equipped with multiple sensors (e.g., microphone, wireless transmitter, global positioning system (GPS) engine, camera, etc.). However, currently there are no applications available that make full use of multiple sensors in an effort to integrate these devices. In other words, multi-sensory technologies that integrate all types of handheld devices are currently not available.

Today, cellular telephones running on state-of-the-art operating systems have increased computing power in hardware and increased features in software in relation to earlier technologies. For instance, cellular telephones are often equipped with built-in digital image capture devices (e.g., cameras) and microphones together with computing functionalities of personal digital assistants (PDAs) and capabilities of personal media players. Since these devices combine the functionality of cellular telephones with the functionality of PDAs and media players (e.g., audio, video), they are commonly referred to as “smart-phones.”

The hardware and software features available in these smart-phones and similar technologically capable devices provide developers the capability and flexibility to build applications through a versatile platform. The increasing market penetration of these portable devices (e.g., PDAs) inspires programmers to build applications, Internet browsers, etc. for these smart-phones.

The Internet continues to make available ever-increasing amounts of information which can be stored in databases and accessed therefrom. For example, digital media can readably be accessed via the Internet and rendered via a smart-phone or other capable device. A user or consumer can purchase music or video (e.g., movies, television broadcasts) via the Internet and thereafter render the purchased media on a portable device such as a smart-phone.

Additionally, with the proliferation of portable terminals (e.g., notebook computers, cellular telephones, PDAs, smart-phones and other similar communication devices) capable of rendering digital media as well as media centers in general, users are becoming more reliant upon the ability to stream this digital media to their devices and media centers. Furthermore, many portable devices are being designed with a geographic location tracking technology such as global position systems (GPS) for reasons of safety, finding travel directions, etc. Thus, it now becomes possible to determine the current context of the user. This location information can be valuable to providing an intelligent media migration experience.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a system that can store states of a ‘session’ (e.g., Internet television, radio, instant messaging) in a network based context and retrieve these states by devices as soon as these devices become part of that context. More particularly, in one aspect, the innovation provides for the ability to save current states of media consumption on a device (e.g., channel, timing) and to recover the states on other devices that are part of the same context thereafter enabling continuation of the media consumption via a disparate device.

Essentially, the innovation can include various device virtualizations which are subsystems that abstract each device used and the physical characteristics of the device. The innovation can further include an inventory service that identifies the device virtualizations that are available as part of the system and a profiling service that defines which device virtualization can be added into the context of the original device based upon a trigger event. Finally, a service logic that defines the continuity service by triggering the corresponding elements of the system is disclosed.

By way of example, when the user decides to pause a media stream (for example on a TV), an event can be generated by the device virtualization corresponding to the specific device within the context that represent the TV being used. This event can trigger a service logic being part of the context which itself generates an event that is returned to the device via the device virtualization in order to offer to the user the ability to use the continuity service.

When the user agrees to use the continuity service, an event can be generated by the device virtualization and transferred to a service logic component via the context. The service logic component receives the event and generates a corresponding event to the media service (present in the context) in order to capture the state of the media consumed by current device. The media service returns the state of the media consumption which are stored as part of the context. It is to be understood that there can be multiple ways to introduce a device in the context, for example the different participants of the context identify the device to be added (e.g., transition from a television to a smartphone), or the device invites itself in the context (e.g., use of a kiosk to prompt transition).

A new device virtualization can be introduced into the context which then receives an event sent by the service logic to offer the continuity service to the new device. Accordingly, once acknowledged, the second device retrieves the states that are stored in the service logic. A request can then be sent to the media service where a stream is generated between the second device and the media service as a function of the state.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a centralized system that facilitates media migration in accordance with an aspect of the innovation.

FIG. 2 illustrates a system that employs device virtualizations to migrate media in accordance with an aspect of the innovation.

FIG. 3 illustrates an example service logic component in accordance with an aspect of the innovation.

FIG. 4 illustrates a sample monitoring component that facilitates generation of a context in accordance with an aspect of the innovation.

FIG. 5 illustrates a block diagram of an interface component that employs a profile generation component to establish migration rules in accordance with an aspect of the innovation.

FIG. 6 illustrates an architecture that employs a machine learning and reasoning component that automates functionality in accordance with an aspect of the innovation.

FIG. 7 illustrates an exemplary flow chart of procedures that facilitate media migration in accordance with an aspect of the innovation.

FIG. 8 illustrates an exemplary flow chart of procedures that facilitate establishment of rules in accordance with an aspect of the innovation.

FIG. 9 illustrates a block diagram of a computer operable to execute the disclosed architecture.

FIG. 10 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

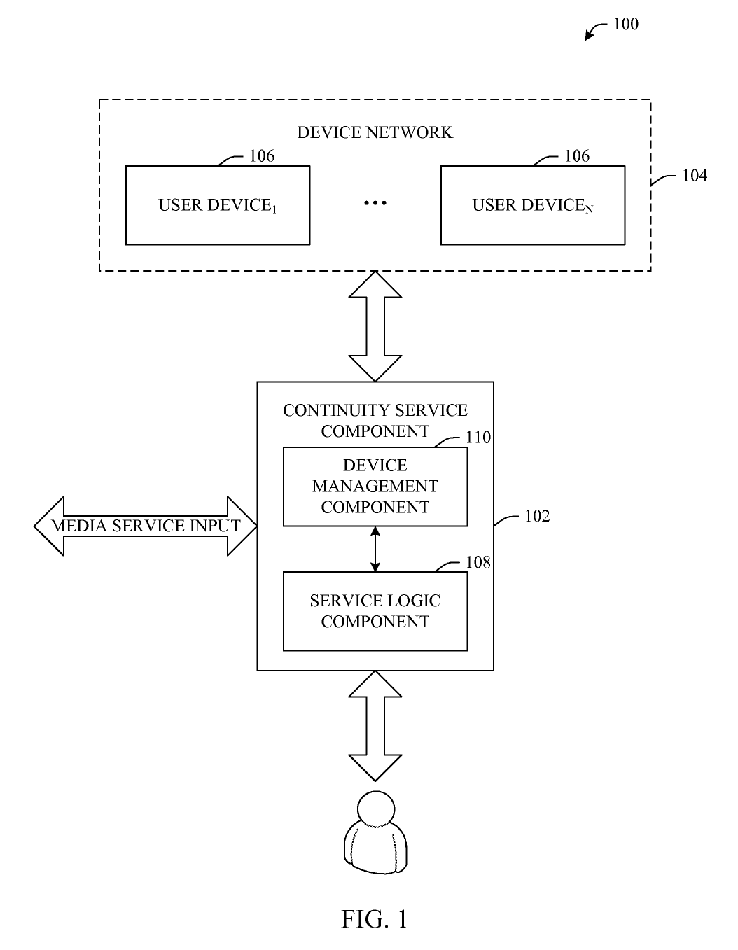

Referring initially to the drawings, FIG. 1 illustrates an example system 100 that facilitates continuity service with regard to media services. In other words, the system 100 can provide mechanisms whereby a media stream can be transferred between capable devices thus providing a user with the flexibility to choose (or have chosen) migration devices to render media. As will be understood upon a review of the figures that follow, the migration (e.g., continuity service) between devices can be explicitly or implicitly triggered by a user and/or some other external contextual factor (e.g., location, activity, preference, inference).

Generally, system 100 can include a continuity service component 102 that enables a media service input to be migrated within a device network 104. As illustrated, device network 104 can include 1 to N user devices capable of rendering the media, where N is an integer. It is to be understood that 1 to N user devices can be referred to individually or collectively as user devices 106. As described above, the user devices 106 can be most any device capable of rendering media services (e.g., audio, video, text messaging, social interaction, instant messaging (IM) session).

Essentially, a user can subscribe to or trigger (e.g., explicitly or implicitly) the continuity service component 102 which can automatically transfer or migrate a media service input based upon a context of or rules provided by a user or by any third party. In other aspects, migration can be user manually initiated as well as based upon machine learning and/or reasoning (MLR) mechanisms as described in greater detail infra. By way of example, suppose a user is viewing an Internet television broadcast via a media center (e.g., device 106). In accordance with the innovation, the user can instruct the continuity service component 102 to transfer the media service input (e.g., television broadcast) to a mobile phone (106) or other capable device.

Similarly, when a user's context changes, for example when a change in location is detected, the continuity service component 102 can prompt a user to acknowledge the transfer, although in other aspects, the acknowledgment can be automatic (e.g., rule-based, inferred). Once acknowledged by the user, the broadcast can be migrated from the media center to the user's cell phone (or other designated device). It will be understood upon a review of the figures that follow, user profiles can be employed to define a migration hierarchy or preference based upon a specific user context. As such, the migration can be effected centrally via the continuity service component 102. Although the continuity service component 102 is illustrated remote from device(s) 106, it is to be understood that the component 102 can be co-located with one or more of the devices 106 without departing from the spirit and/or scope of the innovation and claims appended hereto.

In order to effectuate the transfer or migration, the innovation provides the ability to save current states of media consumption (e.g., channel, timing, other session process characteristics) thereafter providing the ability to recover the state(s) on other devices (106) that are connected to the same context, for example, using a connected service framework (CSF). Thus, the media consumption can be continued on the subsequent device(s) in accordance with the captured state information. It is to be understood that CSF refers to a specific service aggregation service oriented architecture (SOA) platform which enables scalable service based solutions. The ‘session’ is the core component of the framework which routes messages between participants. It is to be understood that other SOA platforms can be employed in accordance with the subject innovation without departing from the spirit and/or scope of the innovation and claims appended hereto.

It is to be understood that the state information stored in the context can vary based upon the media consumption activity and can also depend on the medium itself. By way of example, in case of live broadcast medium (e.g., Internet television or radio), the state stored in the context can be the channel watched. In another example, in the case of an on-demand medium, the states stored can be the program on-demand together with the timing within the program itself.

Returning to FIG. 1, continuity service component 102 can include a service logic component 108 and a device management component 110. Essentially, the service logic component 108 can be employed to manage the state(s) associated with the context. Thereafter, the device management component 110 can be employed to select an appropriate device based upon a user preference (e.g., profile), preprogrammed rule(s) or MLR. Once an appropriate rendering device (106) is selected, the service logic component 108 can be employed to convey the captured state and thereafter enable continuity of the media service as described herein.

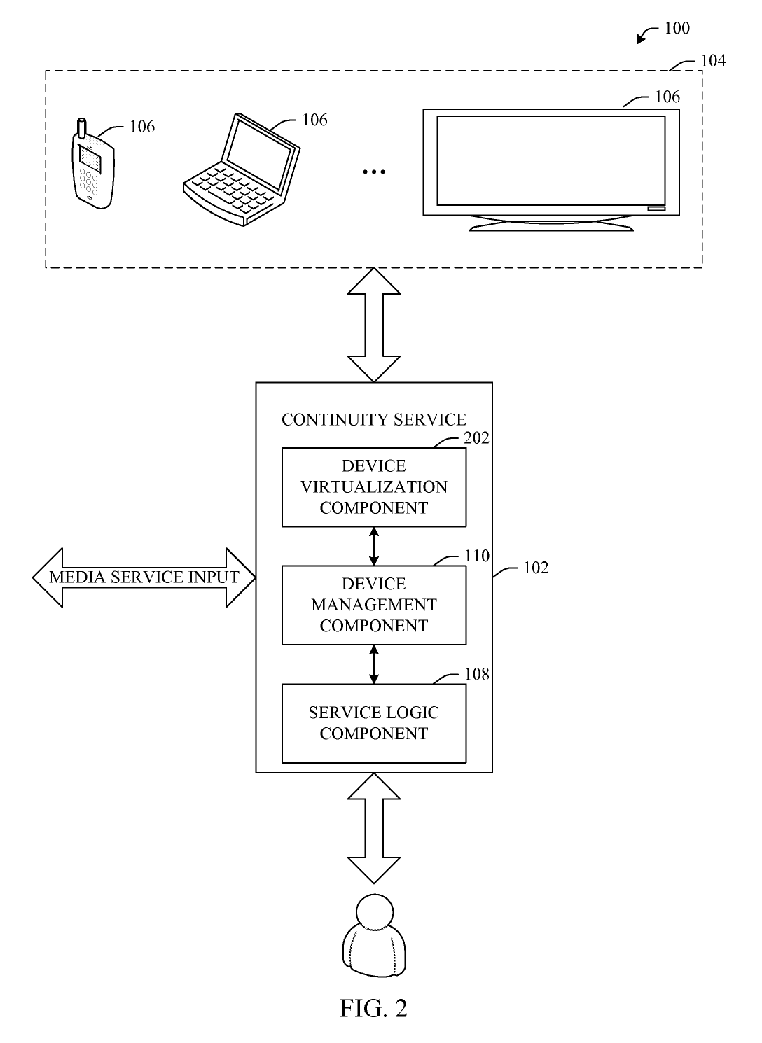

Referring now to FIG. 2, an alternative block diagram of system 100 is shown. The system 100 includes continuity service 102 having a service logic component 108, a device management component 110 and a device virtualization component 202. In operation, the device virtualization component 202 can provide a virtualized representation (e.g., state, context, capabilities) of each of the available devices 106. As shown, in one example, available devices can include a smart-phone, laptop, television or the like.

Continuing with the example, the service logic component 108 can maintain a context, for example, a context that is supported by a CSF (connected services framework). The device virtualization component 202 can establish various device virtualizations which are represented as subsystems that are used to abstract each device 106 available as well as the physical characteristics of the device. The device management component 110 can maintain an inventory service that identifies the available device virtualizations that are available as part of the system.

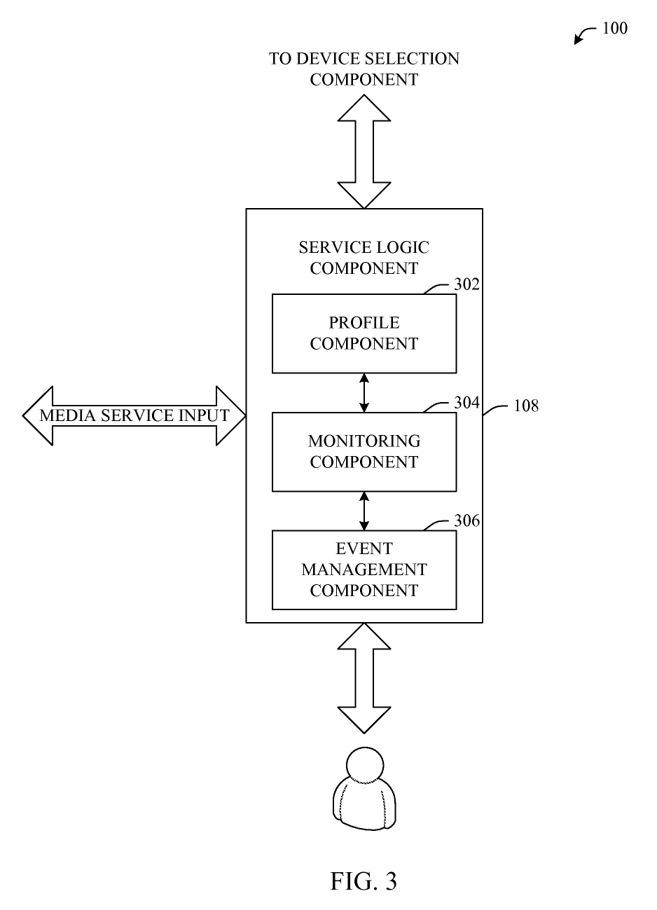

Referring now to FIG. 3, a block diagram of an example service logic component 108 is shown. Generally, the service logic component 108 can include a profiling service (e.g., profile component 302) that defines which device virtualization can or should be added into the context based upon a trigger event (e.g., user action, change in location, change in other contextual factor). A monitoring component 304 can be provided to monitor factors related to triggering events defined by the profile component 302. Finally, an event management component 306 can be employed to create events when prompted by the monitoring component 302 in view of the profile component 302. Through the use of these three components (302, 304, 306), the service logic component 306 defines the continuity service by triggering the corresponding elements of the system.

The following example is provided to add perspective to the innovation and is not intended to limit the innovation in any way. As such, it will be appreciated that most any network device can be employed in connection with the continuity service functionality described herein. In one example, consider a device such as a personal computer (PC) that runs a media center and belongs to a specific context. This device 106 can consume a media stream (e.g., broadcast, on-demand or the like) via the media service. Similarly, other types of virtualized devices can be included in the context, for example, sensors and actuators that can generate events about the fact that the user is changing location. In this scenario, for example, events can be automatically generated if the user leaves the room an actuator may identify the absence and trigger an event that will cause an automatic transfer of media from a first device (e.g., television) to a second device (e.g., the mobile phone).

In accordance with this example, when the user decides to ‘pause’ the media stream, an event can be generated that identifies the affected device virtualization, which in this case, corresponds to the PC in the context. It will be appreciated that each of the devices can be equipped with functionality to generate event triggers. As well, in the aspect described here, the monitoring component 304 can be employed to facilitate dynamic update of the device virtualization, for example with respect to generation of a triggering event.

This event triggers the service logic component 108 which itself generates an event (e.g., via event management component 306) that is returned to the PC via the device virtualization component (202 of FIG. 2) in order to offer to the user the ability to employ the continuity service. Although this example includes a notification and/or query to a user with regard to use of the continuity service functionality, it is to be understood that rules and/or MLR mechanisms can be employed to fully or partially perform these actions on behalf of a user.

Continuing with the example, when the user agrees (e.g., by performing an action, by being observed, by rules, by inference) to use the continuity service by clicking on the corresponding option, an event is generated by the device virtualization component 202. The service logic component 108 receives the event and generates an event to the media service (shown as media service input) in order to capture the state of the media consumed by the user with the PC. The media service returns the state(s) of the media consumption which can be stored (e.g., cached, buffered) as part of the service logic component 108. Although the examples described herein are directed to ‘media’, it is to be understood that media service is not necessary about a television stream, for example, ‘media’ could be voice, video, transfer of data, etc. In the telecommunications industry, this is sometimes referred to as a ‘bearer channel.’

The profile component 302, based on its own configuration as a function of the same event generated by the device virtualization component 202, can introduce a new device virtualization into the context which then receives an event sent by the service logic component 302 to offer the continuity service via the new device 106. As shown, this device 106 can be a mobile phone and the event can be transported via a protocol such as SMS to indicate that the continuity service is available and in use.

Thereafter, the user can employ the second device 106 to retrieve the states that are stored in the service logic component 108. By receiving the states into the second device 106, a request to the media service is made and a stream is generated between the second device and the media service that corresponds to the identified state(s). In other words, the media stream can be continued on the second device 106 as a function of the stored state(s).

It is to be understood that the profile component 302 can be employed not only to select the second device 106 based upon a given context but, also, to provide device parameters that represent the characteristics of the second device. These device parameters can be communicated to the media service such that the media service can select an appropriate format in view of the second device 106. In another aspect, a transcoder (not shown) can be provided within the context to adapt or configure the media stream from the media service ‘on-the-fly’ or ‘just-in-time’ into a format the second device is capable to consume.

Continuing with the aforementioned example, another way to continue the media consumption is to have yet another (e.g., a third) device virtualization that is part of the inventory and therefore registered for use within the continuity service. By way of example, a kiosk can be employed to enable a user to transfer and/or access media streams between devices. Essentially, in operation, the user can log into the kiosk (or other device) which will effectuate the addition of the new device into the context. Once the device is in the context the same sequence (e.g., as described supra with respect to a second device) of events can be produced. Thus, after a selection by the user for the corresponding states, a media stream can be established between the media service and the third device effectively transferring the stream between devices as desired.

It is to be understood that the innovation described herein can be applied to most any broadcast media (e.g., television, radio), on-demand media (e.g., music, live or recorded television, movies). Furthermore, the scenario as well as the overall innovation can apply to most any session driven activity, for example, the ability to continue an IM session or a voice-over-Internet-protocol (VOIP) conversation.

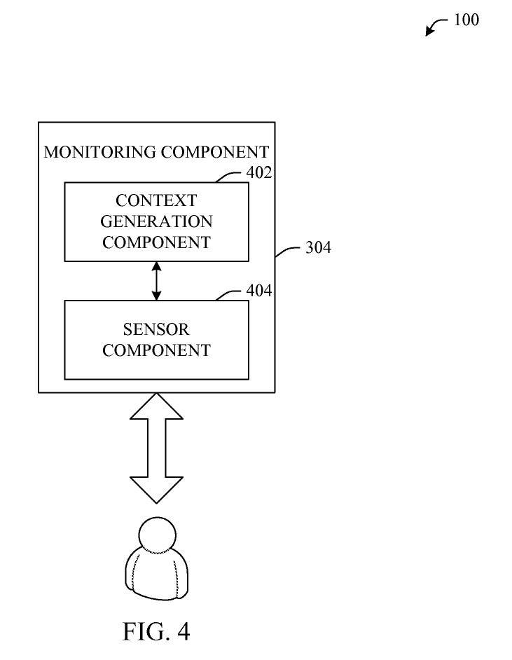

Turning now to FIG. 4, a block diagram of an example monitoring component 304 in accordance with an aspect of the innovation is shown. Generally, monitoring component 304 can include a context generation component 402 and a sensor component 404. Essentially, these two components (402, 404) enable dynamic monitoring of a user context and device availability.

In operation, sensor component 404 can be employed to establish a context related to a user and/or device. For example, sensor component 404 can employ global positioning system (GPS) data to determine a location of a user or device. As such, this location information can be employed in connection with the profile component (e.g., 302 of FIG. 3) in order to determine or locate an appropriate and proximate migration device (e.g., location-aware system). Additionally, this location information can be employed by the context generation component 402 and combined with additional sensory data (e.g., activity data, motion data, temporal data, calendar data) in order to establish a context. It is to be understood and appreciated that the context generation component 402 can use most any information available (e.g., personal information manager (PIM) data, activity data, historical data) to establish context. Once a context is established, the system can employ this context in order to determine a device to automatically migrate or to suggest to a user.

As described above, sensor component 404 can be employed to determine a location of a user which can be used to determine proximate devices. Similarly, PIM data can be employed to determine if a user will be using a particular available device for purposes other than receiving media services. For instance, PIM data may indicate that a user will be attending a conference call via mobile phone at a particular time of day. As such, the system can automatically suggest an alternative device (e.g., monitor within a vehicle, laptop) for migration of media services.

Additionally, the innovation can be used to migrate recorded as well as live media streams. With respect to live media streams, the innovation can enable a user to continue the media live (e.g., in real-time) or in a recorded format. As described supra, the state of the media can be captured and employed in order to recreate a time or point of interruption.

In order to facilitate effective process of real-time broadcasts, the innovation can employ a recording service component (not shown) which can be triggered when the continuity service is used in case of ‘live’ or real-time medium. As described above, the recording service component (not shown) can provide the ability to resume the broadcast medium at the time of the trigger of the continuity service rather than the time the continuity service is triggered on the second device.

It will be appreciated that in addition to the cross-device migration described above, the device virtualization functionality of the innovation described herein enables the ability to roam across networks, for example, from one network (e.g., WIFI) to another (e.g., GPRS). Yet another benefit of device virtualization is the ability to migrate across domains in addition to devices and networks.

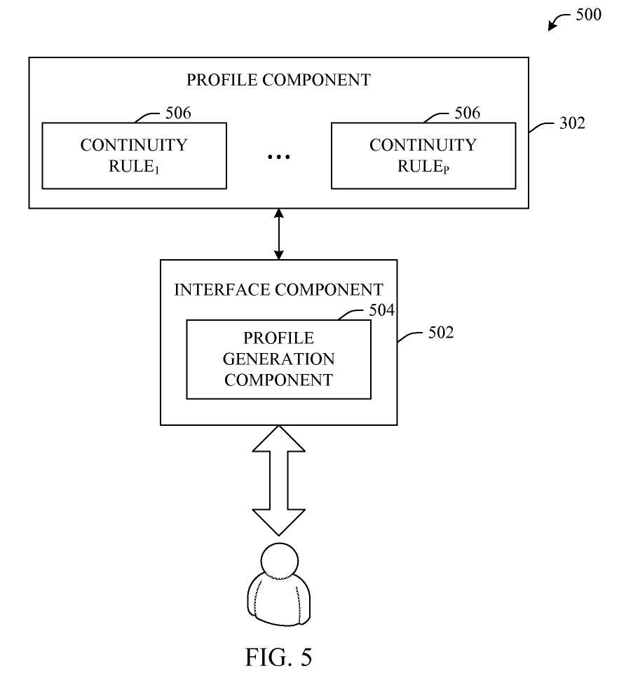

Referring now to FIG. 5, a system 500 that facilitates configuration of profile component 302 is shown. As illustrated, system 500 includes an interface component 502 that enables a user to interact with a profile generation component 504 to establish 1 to P continuity rules, where P is an integer. It is to be understood and appreciated that 1 to P continuity rules can be referred to individually or collectively as continuity rules 506.

In accordance with system 500, an implementation scheme (e.g., rule) can be applied to define a continuity preference of a user. It will be appreciated that the rule-based implementation can automatically and/or dynamically migrate a media stream in accordance with a preprogrammed rule 506.

By way of example, a user can establish a rule that automatically captures a state of media input upon a trigger (e.g., user action (explicit or implicit). As well, the rule can define a migration hierarchy based upon factors including, but not limited to, location, media type, time of day or any other context associated therewith. It will be appreciated that any of the specifications utilized in accordance with the subject innovation can be programmed into a rule-based implementation scheme.

In the exemplary aspect of FIG. 5, the profile generation component 504 can be employed to program and/or configure rules 506 in accordance with a user-defined preference. As well, a rule can be established in accordance with a specific hardware configuration or in accordance with a media type. For example, a rule can be constructed in accordance with specific memory capacity and/or display characteristics of a device. In other words, as previously discussed, a rule can be established to take into consideration the specific limitations of a hardware device (e.g., display characteristics) when determining or suggesting a migration device. Thus, in one aspect, if a specific handheld device has a display with extremely limited capabilities, a rule can be generated to bypass this device when the media requires a higher resolution device than is available.

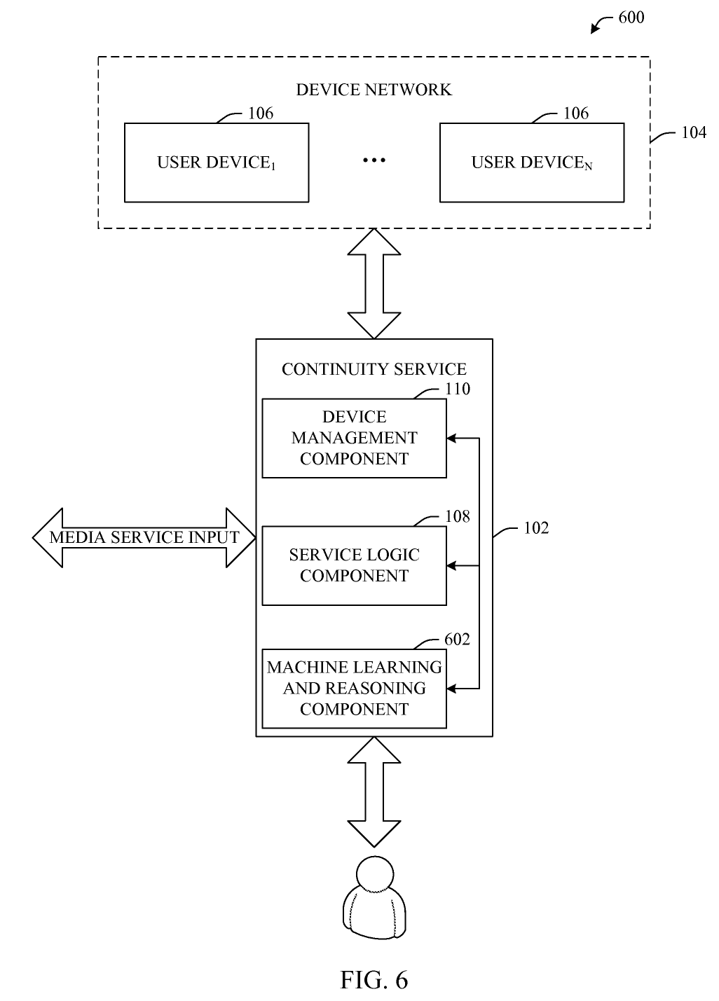

FIG. 6 illustrates a system 600 that employs an MLR component 602 which facilitates automating one or more features in accordance with the subject innovation. The subject innovation (e.g., in connection with triggering the continuity service) can employ various MLR-based schemes for carrying out various aspects thereof. For example, a process for determining when to initiate and/or how to implement the continuity service can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria, when to trigger the continuity service, whether or not to cache media (e.g., in the case of ‘live’ broadcasts), which migration device to select, etc. Essentially, it is to be understood and appreciated that most any of the aforementioned functionality can be carried out in connection with MLR-based mechanisms.

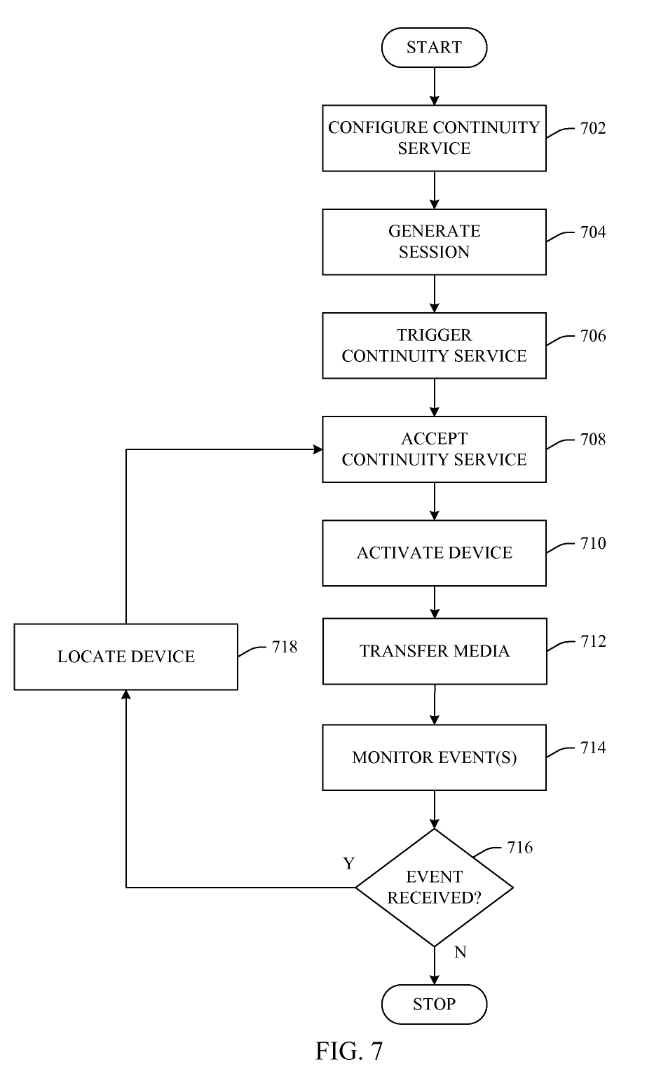

FIG. 7 illustrates a methodology of centrally transferring media in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 702, the continuity service can be configured. For instance, as described above, rules, preferences, hierarchies, etc. can be established in order to manage triggering as well as migration of media to specified devices. Although the flow diagram of FIG. 7 includes configuration of the continuity service, it is to be understood that this configuration can be pre-preprogrammed or programmed just-in-time (e.g., when triggered) in order to manage migration.

A session can be generated at 704. As described above, the session can range from watching Internet television, to listening to ‘live’ radio broadcasts, to an IM or other communication session. In order to add perspective to the innovation, the flow diagram will be described with reference to a session that includes viewing an Internet television programming channel.

The continuity service can be explicitly or implicitly triggered at 706. In operation, a user can decide explicitly to trigger the continuity service, for example, if the user needs/wants to migrate the media to a different device. As well, trigging can occur implicitly, for example, when a user travels or a device becomes unavailable. In the implicit scenario, sensors and other monitoring devices can be employed to assist in triggering the continuity service.

In one aspect, a notification can be sent to a user that requires acceptance in order to migrate the media. For example, once the continuity service is triggered at 706, the system can, based upon a profile or other criteria, send a notification to a migration device. Once the notification is received, the user can accept the continuity service thereby effectively activating the service on the new device at 710.

Once the continuity service is activated on the new device at 710, the media can be transferred at 712. As described above, the state of the media can be captured when the continuity service is triggered at 706 and employed at 712 in order to transfer the media. As well, the media can be configured to comply characteristics of the new device. As an example, the media can be reconfigured in accordance with the display characteristics of the target device.

Future events can be monitored at 714 with regard to the continuity service. For instance, the system can automatically monitor context data in order to manage appropriate media migration(s). A determination can be made at 716 if an event is received. If so, a new target device can be located at 718 and the flow can return to 708 where the continuity service can be accepted.

By way of example, suppose a user travels outside of a service area such that a current device is no longer available to receive a media stream. As such, an event can be generated and an appropriate device located for migration. Next, a notification request can be sent to the new device for user acknowledgment. Once acknowledged, the device can be activated and media transferred. Similarly, in another aspect, an event can be explicitly generated by a user in order to prompt transfer of media.

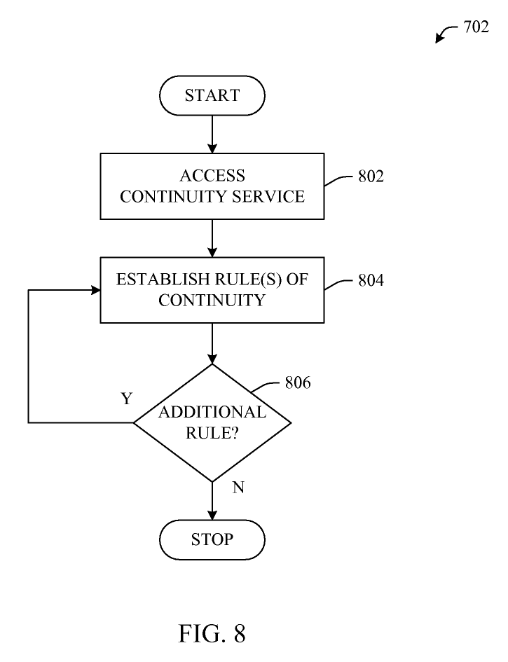

Referring now to FIG. 8, there is illustrated a methodology of configuring a plurality of implementation rules in accordance with the innovation. Essentially, the flow diagram of FIG. 8 illustrates the act of configuring the continuity service (e.g., 702 of FIG. 7). At 802, a user can access the continuity service at 802. For example, a graphical user interface (GUI) can be employed to interface with the continuity service. A rule can be established at 804, for example, a migration hierarchy based upon contextual factors can be defined and incorporated into an implementation scheme (e.g., rule).

A determination can be made at 806 if an additional rule is to be defined. If so, the flow returns to 804 where the details of the rule can be established. If not, a stop block is reached. By way of example, it is to be understood that these rules can establish a migration preference/order with regard to available devices.

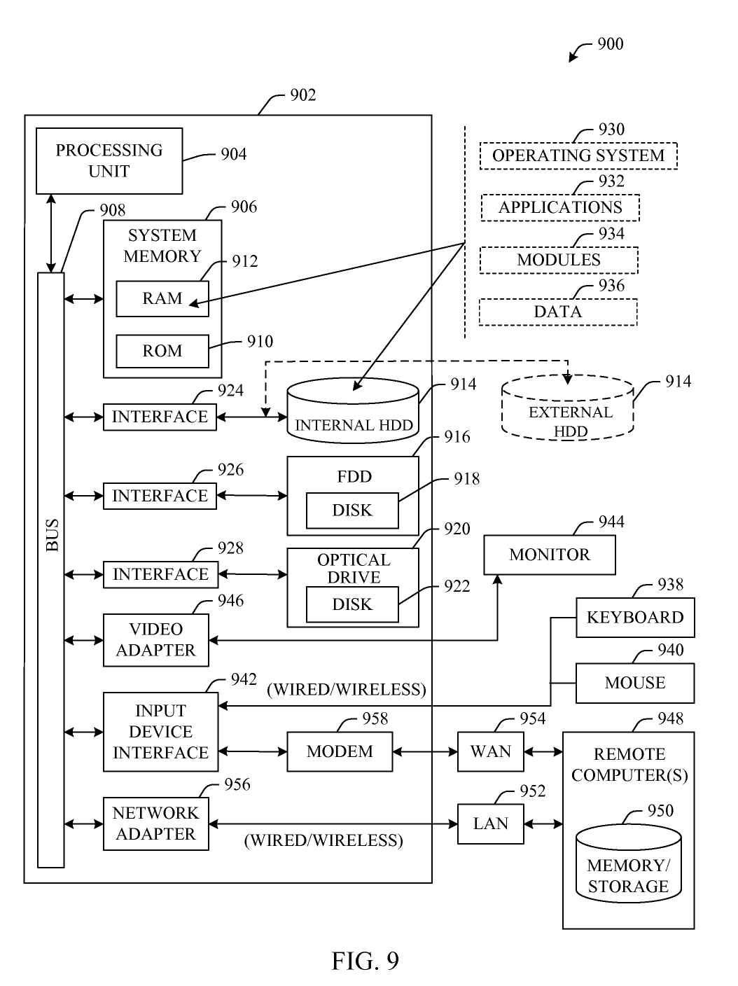

Referring now to FIG. 9, there is illustrated a block diagram of a computer operable to execute the disclosed architecture. In order to provide additional context for various aspects of the subject innovation, FIG. 9 and the following discussion are intended to provide a brief, general description of a suitable computing environment 900 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects of the innovation includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the innovation can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

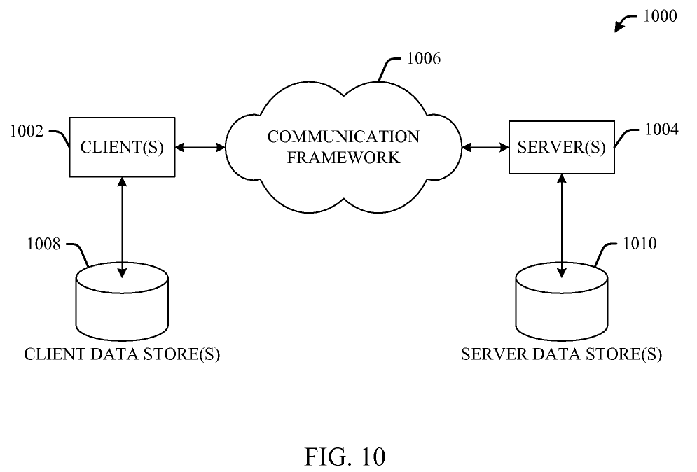

Referring now to FIG. 10, there is illustrated a schematic block diagram of an exemplary computing environment 1000 in accordance with the subject innovation. The system 1000 includes one or more client(s) 1002. The client(s) 1002 can be hardware and/or software (e.g., threads, processes, computing devices). The client(s) 1002 can house cookie(s) and/or associated contextual information by employing the innovation, for example.

The system 1000 also includes one or more server(s) 1004. The server(s) 1004 can also be hardware and/or software (e.g., threads, processes, computing devices). The servers 1004 can house threads to perform transformations by employing the innovation, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A continuity service system that facilitates management of media, comprising:
a context in which a plurality of components collaboratively participate in decisions of transferring a media;
a device management component that maintains an inventory of the plurality of devices; and
a service logic component that migrates the media from a current device to one of the plurality of devices as a function of the context.

2. The system of claim 1, the service logic component captures a state of the media and employs the state to migrate the media.

3. The system of claim 1, the plurality of devices includes at least one of a television, laptop computer, desktop computer, mobile telephone, personal data assistant and smartphone.

4. The system of claim 1, further comprising a device virtualization component that establishes a virtual representation of each of the plurality of devices, wherein the service logic component employs the virtual representations to migrate the media.

5. The system of claim 1, further comprising a profile component that identifies at least one of a user preference and a device migration hierarchy as a function of the device virtualizations.

6. The system of claim 1, further comprising a monitoring component that monitors the context associated to the current device and facilitates update of the inventor of the plurality of devices.

7. The system of claim 6, further comprising an event management component that manages a plurality of events, a subset of the events facilitates migration of the media.

8. The system of claim 7, further comprising a context generation component that establishes the context.

9. The system of claim 8, further comprising a sensor component that captures criteria associated with one of a user and the current device, wherein the criteria is employed to establish the context.

10. The system of claim 1, further comprising an interface component that facilitates a user to employ a profile generation component to define a plurality of rules, wherein the plurality of rules define a migration policy used by the service logic component to migrate the media.

11. The system of claim 1, further comprising a machine learning and reasoning component that employs at least one of a probabilistic and a statistical-based analysis that infers an action that a user desires to be automatically performed.

12. A method of continuing media consumption between devices, comprising:
activating a continuity service that defines a context in which a plurality of components collaboratively participate in decisions of transferring a media;
capturing a current state of the media consumption within the context;
identifying a target device within the context; and
transferring the media to the target device as a function of the current state.

13. The method of claim 12, further comprising notifying a user of the continuity service via the target device.

14. The method of claim 12, further comprising:
recording the media as a function of the current state; and
replying the recorded media on the target device.

15. The method of claim 12, the act of activating the continuity service includes entering a user login information.

16. The method of claim 12, further comprising accessing a migration rule that identifies the target device.

17. The method of claim 16, further comprising programming the migration rule in accordance with a user preference.

18. A media continuity service, comprising:
means for establishing a context in which components collaboratively participate in decisions of consuming media;
means for monitoring state of a session;
means for generating an event related to the context of the session; and
means for migrating the state of the session from a current device to a target device based upon the event when the target device enters the context.

19. The service of claim 18, further comprising means for identifying the target device as a function of the context.

20. The service of claim 18, further comprising means for recording the session as a function of the state.
